(19) United States
(12) Patent Application Publication
(10) Pub. No.: US 2016/0039351 A1
(43) Pub. Date: Feb. 11, 2016

(54) LOAD CARRIER ASSEMBLIES FOR SECURING A LOAD TO A VEHICULAR CROSSBAR

(71) Applicant: Thule Sweden AB, Hillerstorp (SE)

(72) Inventors: Ash PATEL, Newton, CT (US); Henrik ERIKSSON, Jonkoping (SE); Jan ADLER, Jonkoping (SE)

(21) Appl. No.: 14/808,775

(22) Filed: Jul. 24, 2015

Related U.S. Application Data
(60) Provisional application No. 62/033,501, filed on Aug. 5, 2014.

(51) Int. Cl. B60R 9/058

(52) U.S. Cl. CPC B60R 9/058

(57) ABSTRACT

A load carrier assembly for releasably securing a load to a crossbar of a vehicular roof rack is disclosed. The load carrier assembly may include a tightenable clamp configured to attach to an exterior of a crossbar, a rotary tightener coupled between two portions of the tightenable clamp, and an actuator coupled to the rotary tightener. The actuator can have an interference surface configured to contact a portion of a load carrier thereby obstructing rotation of the rotary tightener and preventing unauthorized removal of the load carrier from the crossbar.

### CROSS-REFERENCE TO RELATED APPLICATIONS

This application claims priority to U.S. Provisional Patent Application No. 62/033,501, filed on Aug. 5, 2014, the disclosure of which is incorporated herein in its entirety by reference thereto.

### FIELD

The present disclosure relates generally to load carriers for releasably attaching a load to a rack (e.g., a vehicular roof rack). More specifically, embodiments within this disclosure relate to lockable load carriers and load carrier assemblies for releasably attaching a load to a rack.

### BACKGROUND

In order to prevent unauthorized removal of cargo, vehicular load carriers have often included keyed locks for securing attachment brackets to load bars. However, it can be desirable to securely attach such brackets by less cumbersome means.

### BRIEF SUMMARY OF THE INVENTION

Some embodiments are directed towards a load carrier assembly including a clamp configured to attach to a crossbar and a load carrier coupled to the clamp. The load carrier including a support bar and a base pad pivotally coupled to the support bar, the base pad being configured to rotate between a closed position and an open position and being configured to obstruct tightening and untightening of the clamp in the closed position.

In some embodiments, the clamp may include a tightening bolt coupled to an actuator configured to tighten and untighten the clamp. In some embodiments, the base pad may be configured to obstruct rotation of the actuator in the closed position. In some embodiments, the base pad may include a lock configured to engage the actuator in the closed position to obstruct rotation of the actuator. In some embodiments, the lock may include a protrusion extending outwardly from a sidewall of the base pad.

In some embodiments, the load carrier assembly may include a locking mechanism configured to lock and unlock the base pad in the closed position.

In some embodiments, the load carrier assembly may include a load support bar coupled to the load carrier. In some embodiments, the load support bar may be pivotally coupled to the load carrier and configured to rotate between a first position and a second position. In some embodiments, the load support bar may include a U-shape having two arms pivotally coupled to the load carrier.

In some embodiments, the load carrier may include a cavity defined by the support bar and the base pad and the cavity may be closed when the base pad is in the closed position. In some embodiments, the load carrier assembly may include a fastener coupling the load carrier to the clamp and disposed within the cavity. In some embodiments, the fastener may be configured to releasably couple to a bolt coupled to the clamp.

In some embodiments, the load carrier assembly may include two clamps, each clamp configured to attach to a crossbar, where the load carrier extends between the two clamps and is coupled to the two clamps.

In some embodiments, the clamp includes a rotary tightener having an actuator, the rotary tightener configured to adjustably couple a lower jaw of the clamp to an upper jaw of the clamp.

Some embodiments are directed towards a load carrier including a support bar having a through hole extending through a bottom wall of the support bar and configured to receive a bolt, a base pad pivotally coupled to the support bar and configured to rotate between a closed position and an open position, a locking mechanism disposed on the load carrier and configured to lock and unlock the base pad in the closed position, and a cavity defined by the support bar and the base pad, the cavity being closed when the base pad is in the closed position, and the through hole being in communication with the cavity.

In some embodiments, the cavity may be open when the base pad is in the open position.

In some embodiments, the load carrier may include a load support bar pivotally coupled to the support bar and configured to rotate between a first position and a second position.

Some embodiments are directed towards a load carrier having a load engagement portion and a plurality of lockable brackets, the lockable brackets including a pair of lockable brackets with a load engagement portion positioned therebetween, each of the pair of brackets including a tightenable clamp having an interior configured to matingly engage about an exterior of a crossbar, a rotary tightener coupled between two portions of the tightenable clamp, and a pinch-engagement actuator coupled to the rotary tightener for transitioning the rotary tightener between a securing and a releasing configuration, where the pinch-engagement actuator includes an interference surface on a lateral side thereof that abuttingly engages the load engagement portion, thereby preventing rotation of the rotary tightener and preventing unauthorized removal of the load carrier from the crossbar.

Some embodiments are directed towards a load carrier assembly for releasably securing a load to a crossbar of a vehicular roof rack, the load carrier assembly including a clamp having an upper jaw and a lower jaw configured to frictionally attach to an exterior of a crossbar, a load carrier coupled to the clamp, a rotary tightener coupled the upper jaw and the lower jaw of the clamp, an actuator coupled to the rotary tightener, the actuator including an interference surface that abuttingly engages a portion of the load carrier in a locked configuration to thereby obstruct rotation of the rotary tightener.

In some embodiments, the actuator is able to rotate when the load carrier assembly is in an un-locked configuration.

### BRIEF DESCRIPTION OF THE DRAWINGS/FIGURES

Implementations of the present application will now be described, by way of example only, with reference to the attached figures, wherein:

FIG. 1 is a downwardly directed perspective view of a top portion of one embodiment of a lockable bracket positioned on a crossbar of a load carrier configured according to the present disclosure.

FIG. 2 is an upwardly directed perspective view of the top portion of the lockable bracket shown in FIG. 1 in a tightening configuration.

FIG. 3 is an upwardly directed perspective view of the top portion of the lockable bracket similar to that shown in FIG. 2, but in a neutral configuration.

FIG. 4 is partial cutaway, upwardly directed perspective view of the top portion of the lockable bracket similar to that shown in FIG. 3 in which the pinch-engagement actuator is in the neutral configuration.

FIG. 5 is an upwardly directed perspective view of the top portion of the lockable bracket similar to that shown in FIG. 3 indicating the pinch-engagement actuator being transitioned from the neutral configuration toward the tightening configuration.

FIG. 6 is a perspective view showing two lockable brackets clamped onto a crossbar with a load carrier installed between pairs of opposite pinch-engagement actuators on each of the brackets and thereby blocking (preventing rotation) the actuators into a locked and securing configuration.

FIG. 7 is a side elevational view of a load carrier and depicting the lockable bracket 100 in a locked configuration, but not on a crossbar.

FIG. 8 is a perspective view of a load carrier assembly according to an embodiment.

FIG. 9 is a perspective view of a load carrier assembly in a closed position according to an embodiment.

FIG. 10 is a zoomed in view of a portion of FIG. 9.

FIG. 11 is a top perspective view of a load carrier assembly in an open position according to an embodiment.

FIG. 12 is a bottom perspective view of a load carrier assembly in an open position.

FIG. 13 is a cross-sectional view of an assembled clamp and load carrier according to an embodiment.

FIG. 14 is a perspective view of a load carrier assembly according to an embodiment.

### DETAILED DESCRIPTION OF THE INVENTION

For simplicity and clarity of illustration, where appropriate, reference numerals have been repeated among the different figures to indicate corresponding or analogous elements. In addition, numerous specific details are set forth in order to provide a thorough understanding of the implementations described herein. However, the implementations described herein can be practiced without these specific details. In other instances, methods, procedures and components have not been described in detail so as not to obscure the related relevant feature being described. Also, the description is not to be considered as limiting the scope of the implementations and embodiments described herein.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other thing that “substantially” modifies, such that the component need not be exact. For example, substantially cylindrical means that the object resembles a cylinder, but can have one or more deviations from a true cylinder. The terms “comprising,” “including” and “having” are used interchangeably in this disclosure. The terms “comprising,” “including” and “having” mean to include, but not necessarily be limited to the things so described.

The present disclosure concerns various components that can be implemented and utilized to releasably secure a load carrier assembly (e.g., a lockable bracket assembly) to an elongate support bar of a vehicular load rack for releasably and lockably securing a load thereto. Load carriers can include, but are not limited to, load carriers which are mountable onto vehicles such as cars and trucks. Load carriers can include, but are not limited to, carriers which can carry boats or kayaks or other types of equipment. While the illustrated examples are provided in relation to a bracket for a load carrier, certain components can be implemented with other devices.

The present disclosure relates to load carrier assemblies (e.g., lockable bracket assemblies) for releasably attaching a load to a rack. The rack may be coupled to a vehicle. In some embodiments, the vehicle may be motorized (e.g., a car, a truck, a four-wheeler, or a motorized boat). In some embodiments, the vehicle may be not be motorized (e.g., a bike). In some embodiments, the rack may not be coupled to a vehicle. For example, the rack may be a stand-alone rack or a rack coupled to the ground/floor, a wall, a ceiling, a table, etc.

The present disclosure relates to a lockable bracket for releasably securing a load to a crossbar of a vehicular roof rack. The bracket can include a tightenable clamp having an interior which is configured to matingly engage about an exterior of a crossbar, a rotary take-up mechanism coupled between two portions of the tightenable clamp, and an operator engageable input coupled to the rotary take-up mechanism. The operator engageable input can be configured for transitioning the rotary take-up mechanism between a contracted and an expanded configuration. The operator engageable input can also include a load-engaging, abutment portion configured to abuttingly engage a portion of a load carrier which is coupled to the bracket in a locked configuration of the bracket, thereby preventing rotation of the rotary take-up mechanism.

In at least one embodiment within this disclosure, the operator engageable input can be a pinch-engagement actuator that comprises an elongate body having a length and a width. In at least one embodiment, the length is greater than the width. In at least one embodiment, the load-engaging, abutment portion of the actuator can be an interference surface that is lengthwise oriented on a lateral side of the pinch-engagement actuator.

In at least one embodiment, a lockable bracket can include a tightenable clamp having an interior configured to matingly engage about an exterior of a crossbar, a rotary tightener coupled between two portions of the tightenable clamp, and a pinch-engagement actuator coupled to the rotary tightener for transitioning the rotary tightener between a secured and a released configuration.

The present disclosure also relates to a load carrier having a load engagement portion and at least one pair of lockable brackets with a portion of the load carrier positioned therebetween. Each of the pair of brackets can include a tightenable clamp having an interior configured to matingly engage about an exterior of a crossbar, a rotary tightener coupled between two portions of the tightenable clamp and a pinch-engagement actuator which is coupled to the rotary tightener for transitioning the rotary tightener between a securing and a releasing configuration. The pinch-engagement actuator can have an interference surface on a lateral side that abuttingly engages the portion of the load carrier, thereby preventing rotation of the rotary tightener and preventing unauthorized removal of the carrier from the crossbar.

In at least one embodiment within this disclosure, a pinch-engagement actuator can include a load-engaging, interference surface on a lateral side thereof that abuttingly engages a portion of a load carrier coupled to the bracket in a locked configuration of the bracket and thereby prevents rotation of the rotary tightener. In at least one embodiment, abutting engagement of the actuator against a load carrier prevents unauthorized removal of the load carrier from a crossbar or load supporting bar or carrier supporting bar to which it is attached.

In at least one embodiment, the pinch-engagement actuator can have an elongate body having a length and a width. The length of the elongate body can be longer than the width. The pinch-engagement actuator can include a load-engaging, interference surface that is lengthwise oriented on the pinch-engagement actuator. The pinch-engagement actuator can be drivingly engaged with the rotary tightener in a tightening configuration in which relative rotation between the pinch-engagement actuator and the rotary tightener is prevented. The pinch-engagement actuator can be spin-engaged or slip engaged with the rotary tightener in a neutral configuration in which relative rotation between the pinch-engagement actuator and the rotary tightener is permitted. This property permits changing the orientation of the pinch-engagement actuator on the rotary tightener without changing tightness. Then, when the load carrier is in place on the brackets, rotary action of the tightener is prevented, and when the load carrier, or a portion of the load carrier, is removed or a moved out of the way (e.g., rotated to an open position), the actuator can be turned to loosen the bracket. This property can be provided by a splined coupling, as will be explained below.

In at least one embodiment, the lockable bracket can comprise a splined coupling between the pinch-engagement actuator and the rotary tightener in the tightening configuration. The splined coupling can prevent relative rotation between the pinch-engagement actuator and the rotary tightener. The splined coupling can be hexagonal or another shape. The splined coupling can releasably fix the pinch-engagement actuator to the rotary tightener. That is, the splined coupling can enable a user to use the actuator to tighten the bracket and also enable a user to adjust the orientation of the actuator without tightening the bracket, by raising the actuator slightly from a tightening configuration. This property can be beneficial because when the bracket is securely tightened to a crossbar, (or the like), the orientation of the actuator will not necessarily be suitable to allow a load carrier to be received by the bracket. The splined coupling can comprise a hexhead on the rotary tightener. Additionally, the splined coupling can comprise a hex-shaped hollow on the pinch-engagement actuator. In at least one embodiment, when the hexhead of the rotary tightener is engaged by the hex-shaped hollow on the pinch-engagement actuator, rotation of the actuator will cause rotation of the hexhead, thereby enabling the actuator to tighten or loosen the bracket. Thus, by virtue of the splined coupling, the pinch-engagement actuator can translate upwardly from a tightening configuration in which the hexhead and hex-shaped hollow are mated, to the neutral configuration, in which rotation of the actuator does not act upon the rotary tightener. In the neutral configuration, the rotational position of the actuator can be adjusted so as to enable the load carrier to be connected to the bracket. The actuator can be suitably sized so that once the load carrier is attached to the bracket, the actuator is not free to rotate, thereby preventing the rotatory tightener from being loosened.

In at least one embodiment, the pinch-engagement actuator can include a pair of cushioned-surface, lateral sides. The lateral sides can be abuttingly engaged with a portion of a load carrier secured by the bracket when in a locked configuration, as described above. In at least one embodiment, at least a portion of a perimeter of the cushioned-surface lateral sides can be chamfered.

In at least one embodiment of the lockable bracket, the tightenable clamp described above can include an upper jaw and a lower jaw coupled together by the rotary tightener. In at least one embodiment, the upper jaw comprises a downwardly concave lower surface. The concave lower surface can enable the lockable bracket to be secured around crossbars of varying sizes and shapes. The lower jaw can also comprise an upwardly concave upper surface, likewise enabling the lockable bracket to be secured around crossbars of varying sizes and shapes.

In at least one embodiment, the rotary tightener of the lockable bracket can include an elongate rod having a threaded portion, which can be engaged by a threaded receiver in the lower jaw. When in the tightening configuration, rotation of the actuator can thus cause the rod to rotate, thereby causing the rod to be driven into the receiver in the lower jaw. In at least one embodiment, the elongate rod can comprise a cylindrical portion which can be mated with the elongate portion.

In at least one embodiment, the bracket can include a spacer, which can be located between the upper jaw and the actuator. The spacer can be in the form of washer-like surface which caps the upper jaw between the hexhead (or hex-shaped portion) and the upper jaw. The spacer can act as a receiving area for the actuator when the actuator is in a tightening configuration or the bracket is in the securing configuration, or both. In at least one embodiment, the rotary tightener is configured to be inserted through at least two apertures in the tightenable clamp.

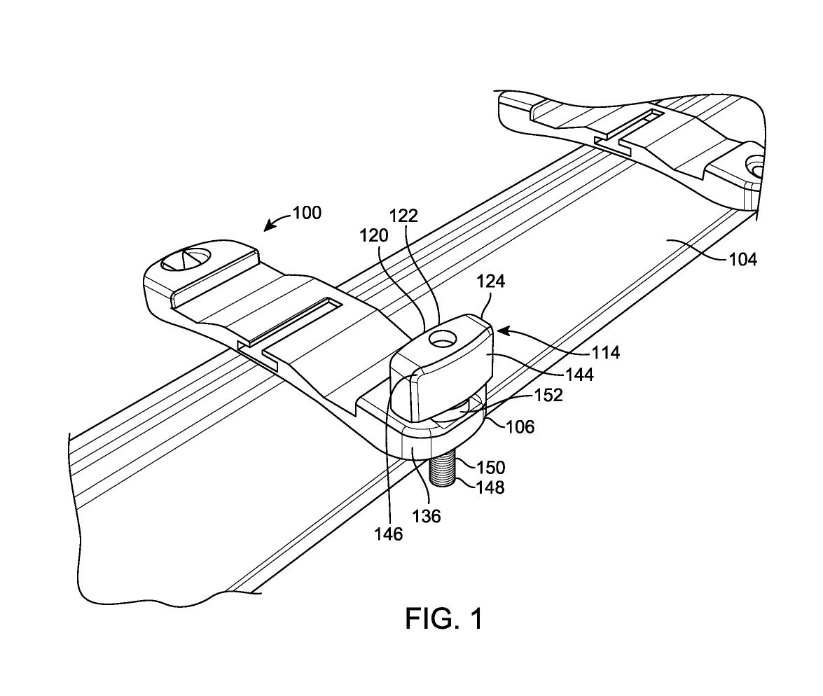

FIG. 1 illustrates an upper view of an embodiment of a lockable bracket 100. The lockable bracket 100 is on a crossbar 104. In some embodiments, crossbar 104 may be a crossbar of a vehicular roof rack. The lockable bracket 100 can be seen to include a pinch-engagement actuator 114. The pinch-engagement actuator 114 has a load-engaging, interference surface 120 which can abut a load carrier (not shown in FIG. 1). The interference surface 120 can be on a lateral side 122 of the actuator 114, as shown. The actuator 114 illustrated has an elongate body 124 with cushioned-surface, lateral sides 144. Actuator 114 has a chamfered surface 146. Actuator 114 can interact with tightening clamp 106, which in the embodiment illustrated consists of at least some portion of upper jaw 136. Actuator 114 resides on upper jaw 136, which can be pressed against crossbar 104 by a tightening rotation of the actuator 114. Actuator 114 can be coupled to elongate rod 148. As shown, elongate rod 148 can have a threaded portion 150. Elongate rod 148 can also include or be coupled to spacer 152, which is broader than threaded portion 150. Spacer 152 can act as a receiver for the remainder of elongate rod 148. An upper portion of spacer 152 can act as landing surface for actuator 114. Spacer 152 can be substantially cylindrical as shown, although other shapes are possible within this disclosure.

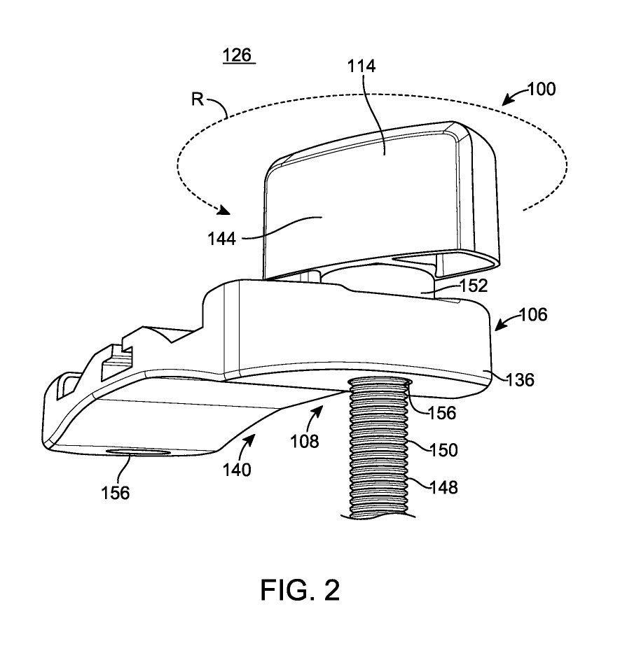

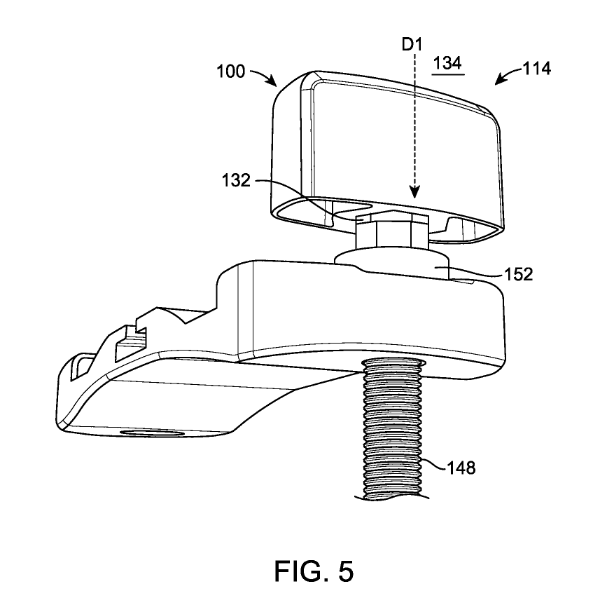

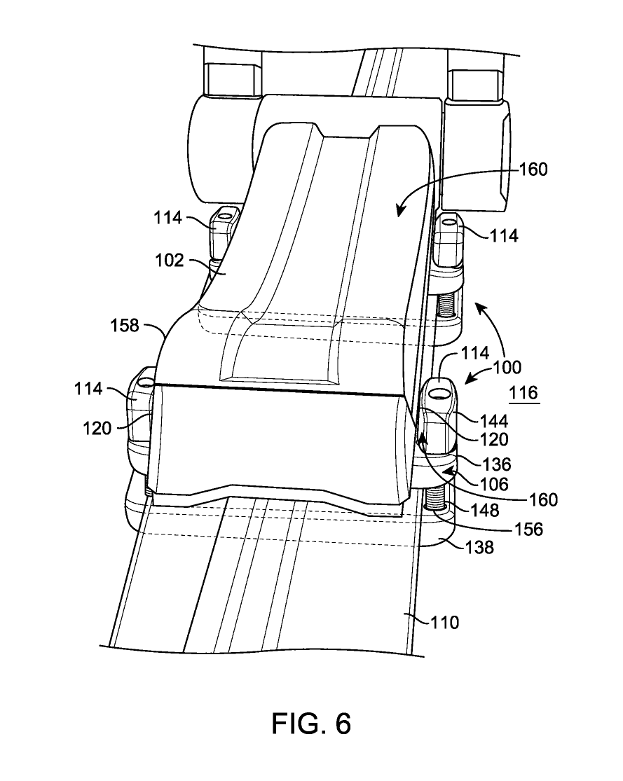

FIG. 2 illustrates an embodiment of the lockable bracket 100 in a tightening configuration 126. When in the tightening configuration 126, the actuator 114 is in contact with spacer 152. Rotation of actuator 114 in direction R can cause the clamp 106 to be tightened against a crossbar. The actuator 114 illustrated also includes cushioned-surface, lateral sides 144. Clamp 106 can be joined or be a part of upper jaw 136 as shown. Upper jaw 136 can include a concave lower surface 140 for gripping a crossbar. Clamp 106 can have an interior 108 for receiving a crossbar. Elongate rod 148 can pass through apertures 156 to mate with a suitable receiver below (not shown in FIG. 2). As previously indicated, elongate rod 148 can have a threaded portion 150 which can be screwed into a suitably configured nut-like receiver (not shown in FIG. 2). As will be explained in greater detail below, actuator 114 and elongate rod 148 can be releasably mated by a splined coupling (not visible in FIG. 2). The splined coupling can allow the orientation of actuator 114 to be adjusted without tightening or untightening lockable bracket 100. Thus, for example if bracket 100 was appropriately tight when the orientation of actuator 114 was as shown in FIG. 2, actuator 114 could block or interfere with placement of a load carrier on clamp 106. The splined coupling allows actuator 114 to be raised and turned and then lowered to an orientation which does not prevent bracket 100 from receiving a load carrier (see FIGS. 5 and 6).

Interior 108 includes a gap defined, in part, by lower surface 140 of upper jaw 136 and an upper surface 142 of lower jaw 138. In some embodiments, the attachment between clamp 106 and a rack or a portion of a rack (e.g., crossbar 104) may be frictional.

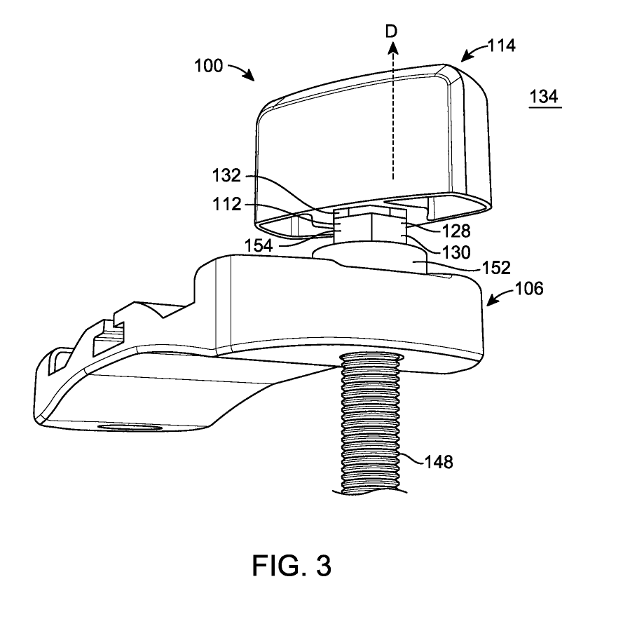

FIG. 3 illustrates an embodiment of the lockable bracket 100 in a neutral configuration 134. In the neutral configuration 134, pinch-engagement actuator 114 is raised slightly with respect to spacer 152 in direction D. As shown, actuator 114 can have a hollow 132 which can mate with a hexhead 130 of elongate rod 148. Also visible is rotary tightener 112, the rotation of which can cause elongate rod 148 to rotate. Hexhead 130 can be form part of a splined coupling 128 between elongate rod 148 and actuator 114.

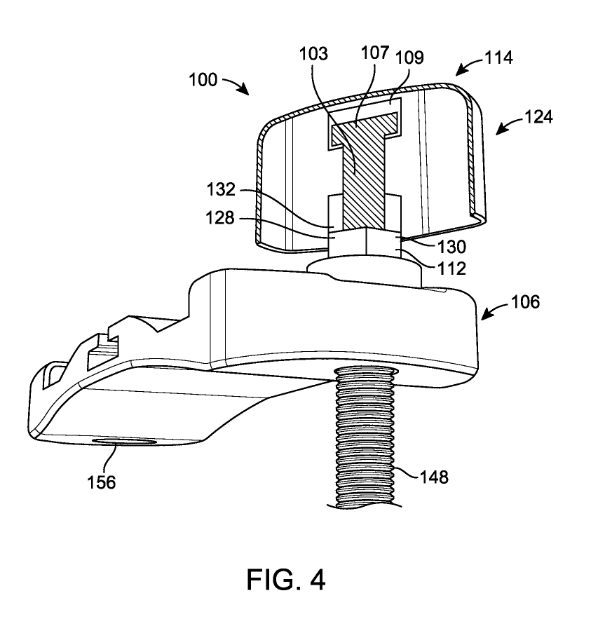

FIG. 4 illustrates a cutaway view of a pinch-engagement actuator 114 of a lockable bracket 100. An upper portion 107 of post 103 rests within cavity 109 of actuator 114. Cavity 109 can be suitably sized to enable the pinch-engagement actuator 114 to be raised to the neutral configuration. Post 107 can be, but does not have to be, integral with elongate rod 148. Again, hollow 132 is suitably shaped to releasably mate with hexhead 130 of rotary tightener 112. As noted above, rotation of rotary tightener 112 can cause tightenable clamp 106 to be tightened against a crossbar.

FIG. 5 illustrates an embodiment of pinch-engagement actuator 114 being transitioned in direction Dl toward a tightening configuration 126, in which hollow 132 will be mated with a hex-shaped portion 154 of elongate rod 148, as described above. Once so mated, the actuator 114 can rotate elongate rod 148. As shown, when actuator 114 is moved in direction D1, actuator 114 moves closer to spacer 152.

FIG. 6 illustrates lockable bracket 100 in a securing configuration 116. The actuator has cushioned-surface, lateral sides 144 each of which may serve as an interference surface 120 to abut against a portion of a load carrier 158. In FIG. 6, the load-engaging, interference surface 120 of the pinch-engagement actuator 114 rests against an engagement portion 160 of load carrier 158. Elongate rod 148 passes through an aperture in clamp 106 formed in upper jaw 136, and into a coupling aperture in lower jaw 138. As described above, actuator 114 cannot rotate because rotation of actuator 114 is blocked by load carrier 158. Thus, in some embodiments, load carrier 158, or a portion thereof, must be removed from crossbar 104 in order for actuator 114 to be rotated and thereby loosen the grip of lockable bracket 100 around crossbar 104.

In some embodiments, engagement portion 160 of load carrier 158 may include a moveable portion 102. Moveable portion 102 may be configured to move between a first position and a second position. In the first position, moveable portion 102 may be positioned such that it does not engage load-engaging, interference surface(s) 120 of the pinch-engagement actuator(s) 114. In the second position, load-engaging, interference surface(s) 120 of the pinch-engagement actuator(s) 114 rest against or immediately adjacent to engagement portion 160, thereby obstructing (and in some cases completely preventing) movement (e.g., rotation) of pinch-engagement actuator(s) 114. This, in turn, substantially prevents removal of bracket 100, and, thus, load carrier 158, from crossbar 104, thereby deterring or preventing theft. In some embodiments, moveable portion 102 may be detached, in whole or in part, from load carrier 158 in the first position.

In some embodiments, moveable portion 102 may be the same as or similar to base pad 840 discussed herein and may include the same or similar functionalities as base pad 840. In some embodiments, moveable portion 102 may lock to load carrier 158 in the second position. In some embodiments, moveable portion 102 may hide and/or prevent unauthorized access to points of attachment between load carrier 158 and one or more clamps 106 when moveable portion 102 is in the second position. In such embodiments, moveable portion 102 may prevent unauthorized decoupling of load carrier 158 from one or more clamps 106 and thus prevent theft of load carrier 158 and/or clamps 106.

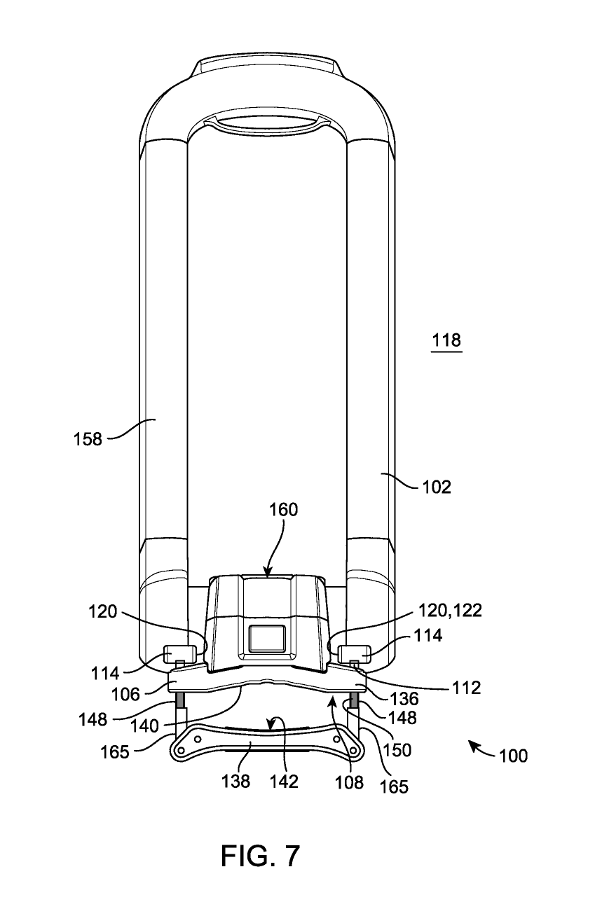

FIG. 7 illustrates a side elevational view of a load carrier 158 comprising a lockable bracket 100. Lockable bracket 100 can be seen to include a tightenable clamp 106 which has an interior 108 configured to matingly engage about an exterior 110 of a crossbar 104 (see FIG. 6, for example). A rotary tightener 112 is shown coupled between two portions of the tightenable clamp 106. The pinch-engagement actuator 114 is coupled to the rotary tightener 112 for transitioning the rotary tightener 112 between a securing configuration 116 and a releasing configuration 118, as described above. As before, the pinch-engagement actuator 114 comprises an interference surface 120 on a lateral side 122 of the actuator 114. The interference surface 120 abuttingly engages the load engagement portion 160 of the load carrier 158, thereby preventing rotation of the rotary tightener 112 and preventing unauthorized removal of the load carrier 158 from a crossbar 104. Also visible, elongate rod 148 which passes through an aperture in upper jaw 136 and tightenable clamp 106. Elongate rod 148 can be seen to have a threaded portion 150 and a cylindrical portion 165. Cylindrical portion 165 can include a female receiver to matingly receive a lead-in end of threaded portion 150. Clamp 106 can be seen to have an interior 108 which can be pressed against a crossbar 104 by a tightening action of the actuator 114. Upper jaw 136 can be seen to have an at least partially concave lower surface 140. Lower jaw 138 is shown to have a concave upper surface 142.

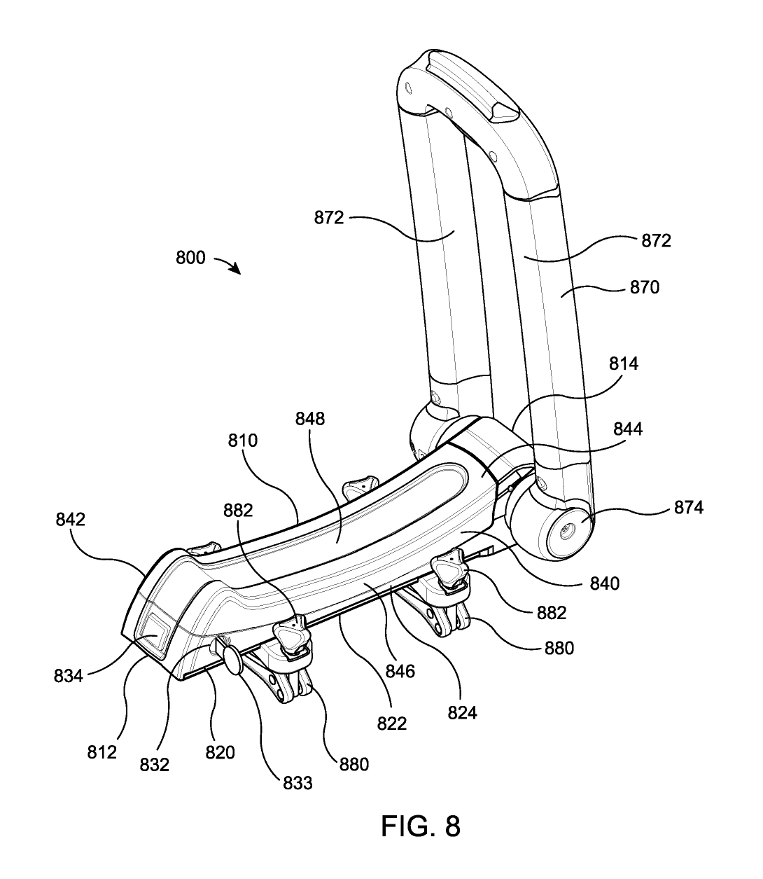

FIG. 8 shows a load carrier assembly 800 according to an embodiment. Load carrier assembly 800 may include a load carrier 810 and one or more clamps 880. Clamp(s) 880 may be releasably coupled to load carrier 810. Clamp(s) 880 may be adjustable clamp(s) configured to releasably attach to a rack or a portion of a rack (e.g., crossbar 104). Each clamp 880 may include one or more actuators 882 configured to tighten and untighten clamp 880. In some embodiments, load carrier assembly 800 may include at least two clamps 880, each clamp 880 being configured to attach to a rack or a portion of a rack. In such embodiments, load carrier 810 may extend between the at least two clamps 880 and may be coupled to each clamp 880.

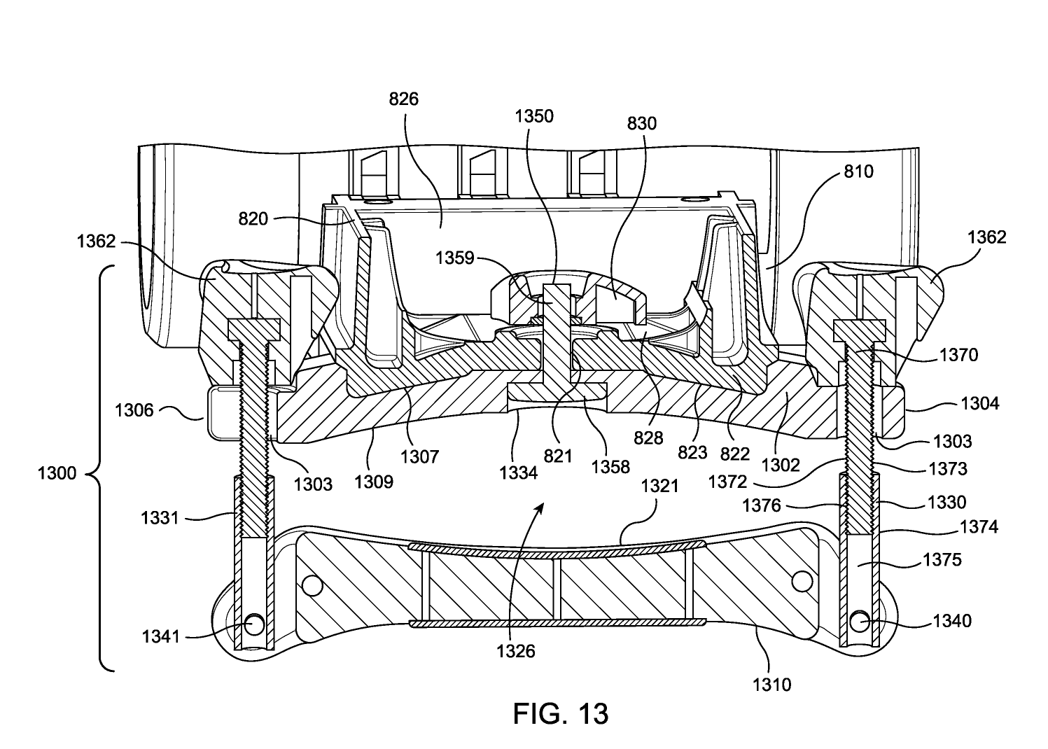

In some embodiments, clamp(s) 880 may be the same or similar to the clamps disclosed in U.S. patent application Ser. No. 14/807,582, entitled “Vehicular Roof Rack Mounting Bracket” and filed on Jul. 23, 2015, the disclosure of which is incorporated herein in its entirety by reference thereto. In some embodiments, clamp 880 may be the same as or similar to clamp 106 or clamp 1300 described below in reference to FIG. 13.

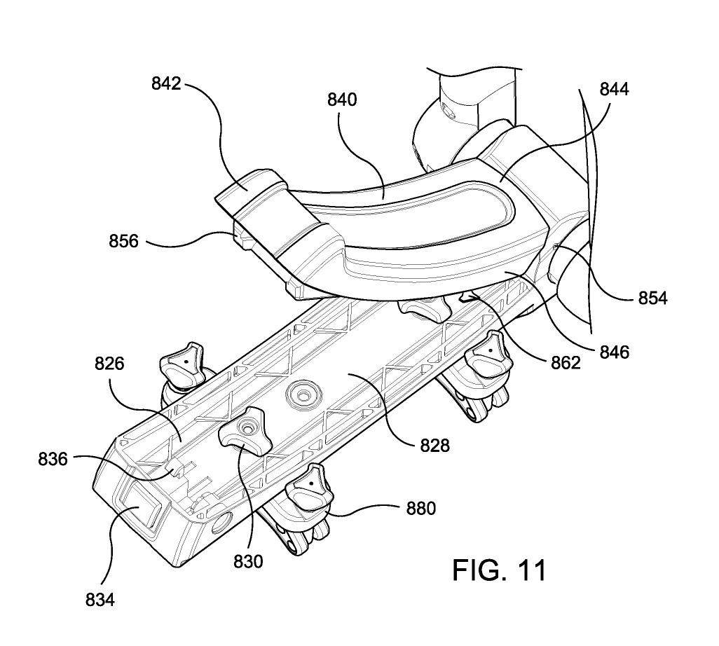

Load carrier 810 may include a support bar 820 and a base pad 840. Base pad 840 may be pivotally coupled to support bar 820 to allow access to a cavity 826 defined by support bar 820 and base pad 840 (see e.g., FIG. 11). In some embodiments, base pad 840 may be pivotally coupled to support bar 820 via a pivot coupling 854 disposed on or adjacent to a second end 814 of load carrier 810. In some embodiments, base pad 840 may be pivotally coupled to support bar 820 on or adjacent to a second end 844 of base pad 840. In some embodiments, pivot coupling 854 may include a shaft about which base pad 840 pivots. In some embodiments, pivot coupling 854 may include one or more hinges.

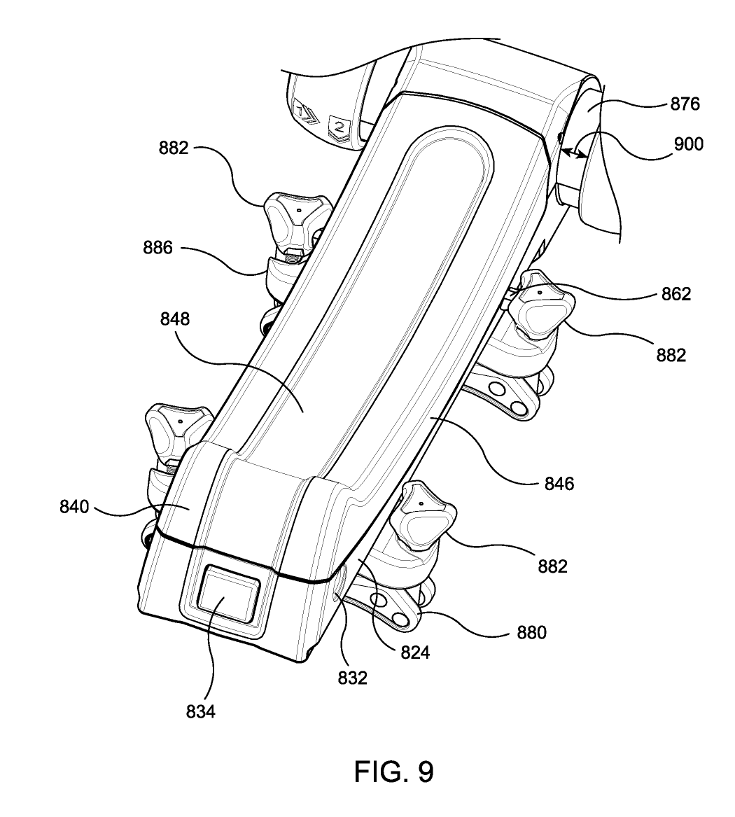

In some embodiments, as shown for example when comparing FIGS. 9 and 11, base pad 840 may be configured to rotate between a closed position (FIG. 9) and an open position (FIG. 11) by the pivotal coupling between support bar 820 and base pad 840. As shown in FIG. 11, when base pad 840 is an open position, cavity 826 defined by support bar 820 and base pad 840 is open (e.g., accessible by an operator). But, as shown in FIG. 9, when base pad 840 is in the closed position, cavity 826 is closed (e.g., not accessible by an operator). In some embodiments, base pad 840 may be locked and unlocked from the closed position as discussed herein.

In some embodiments, cavity 826 may be defined by a bottom wall 822 and a sidewall of 824 of support bar 820 and a bottom surface 850 of base pad 840. In some embodiments, load carrier 810 may be a lockable load carrier. In such embodiments, access to cavity 826 (e.g., movement of base pad 840 from the closed position to the open position) may be controlled by a locking mechanism disposed on load carrier 810.

In some embodiments, support bar 820 may include a locking mechanism 832 configured to lock and unlock base pad 840 in the closed position. In some embodiments, locking mechanism 832 may be disposed on support bar 820 opposite the location of pivot coupling 854 (e.g., locking mechanism 832 may be disposed on or adjacent to first end 812 of load carrier 810 if pivot coupling 854 is located on or adjacent to second end 814, or vice versa). Locking mechanism 832 may include a keyed mechanism that may be actuated with a particular device (e.g., a key) or upon entry of a particular code or combination. In some embodiments, locking mechanism 832 may include a mechanical mechanism, such as but not limited to a combination lock, or a tumbler lock. In embodiments including a tumbler lock, a key 833 may be used to lock and unlock locking mechanism 832. In some embodiments, locking mechanism 832 may include an electronic mechanism, such as but not limited to a scanner/reader (e.g., bar-code scanner or RFID (radio-frequency identification) reader) or an electronic user interface for receiving a code or combination from an operator (e.g., numeric or alphabetic code). As a non-limiting example, locking mechanism 832 may include a plurality of buttons, each corresponding to a number (or group of numbers) to allow an operator to enter a numerical code, which locks and unlocks locking mechanism 832. In the locked position, a portion of locking mechanism (e.g., a latch or bolt) may be configured to engage a portion of base pad 840 when base pad 840 is in the closed position (e.g., like a lockable door).

When in the closed and/or locked position, base pad 840 may be configured to obstruct tightening and untightening of one or more clamps 880 of load carrier assembly 800. In some embodiments, base pad 840 may be configured to obstruct movement (e.g., rotation) of one or more actuators 882 of a clamp 880 (and therefore tightening and untightening of a clamp 880). In some embodiments, base pad 840 may include one or more locks 860 configured to obstruct movement/rotation of one or more actuators 882 when base pad 840 is in the closed position. In some embodiments, lock(s) 860 may include one or more locking protrusions 862 that extend outwardly from a sidewall 846 of base pad 840. In some embodiments, lock(s) 860 may be a separate piece attached to base pad 840 via, for example, one or more fasteners and/or welding. In some embodiments, lock(s) 860 may be coupled to bottom surface 850 of base pad. In some embodiments, lock(s) 860 may be integrally formed with base pad 840. In some embodiments, lock(s) 860 and/or locking protrusion(s) 862 may be integrally formed with sidewall 846 of base pad 840.

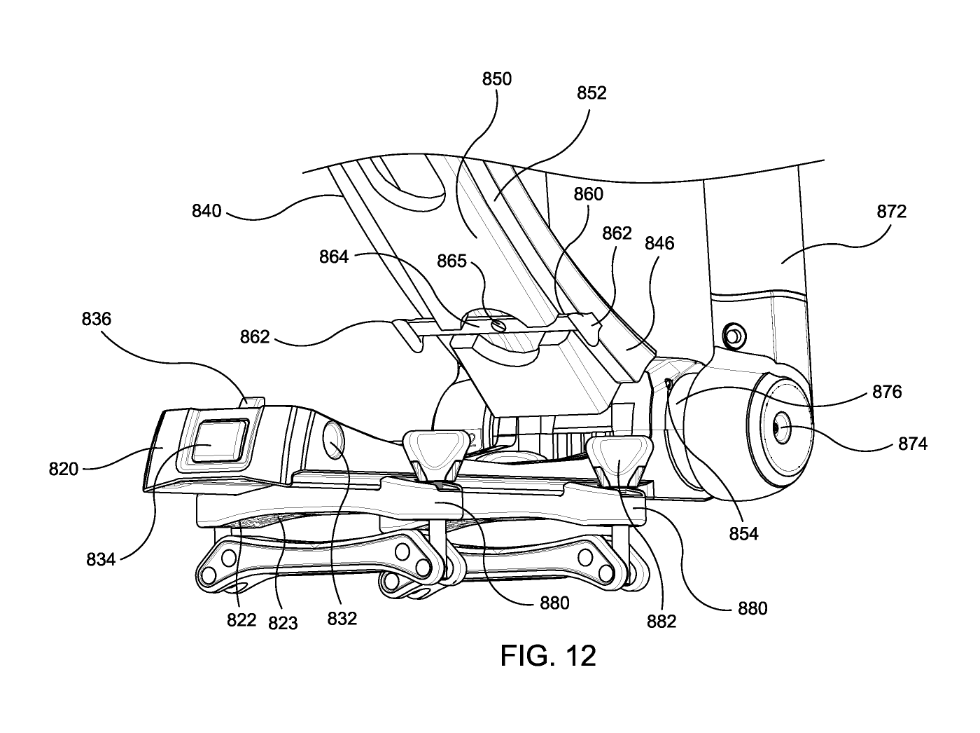

In some embodiments, as shown for example in FIG. 12, lock 860 may include a bar 864 coupled to base pad 840. Bar 864 may include one or more locking protrusions 862 that extend outwardly from sidewall 846 of base pad 840 (e.g., from opposite sides of sidewall 846). Bar 864 may be coupled base pad 840 via for example, welding and/or a fastener 865 (e.g., a rivet, a threaded screw, or a threaded bolt and nut). In some embodiments, bar 864 may be coupled to base pad 840 at a location corresponding to the location of cavity 826 so that bar 864 cannot be removed from base pad 840 unless base pad 840 is in the open position. In some embodiments, sidewall 846 of base pad 840 may include a recess 852. In some embodiments, a portion of lock(s) 860 and/or locking protrusion(s) 862 may be located within recess 852.

In operation a lock 860, and more specifically a locking protrusion 862, may be configured to engage a portion of an actuator 882 to obstruct movement/rotation of the actuator 882. In some embodiments, locking protrusion 862 may be configured (e.g., sized and shaped) to engage (e.g., abuttingly engage) a groove 886 disposed on an interface surface 884 of an actuator 882. As a non-limiting example, locking protrusion 862 may include a hemispherical shape configured to engage a groove 886 having a hemispherical shape. As another non-limiting example, locking protrusion 862 may include a flat end configured to contact a flat, or substantially flat, surface of an actuator (e.g., a lateral side 122, 144 of a pinch-engagement actuator 114 shown in FIGS. 1-7).

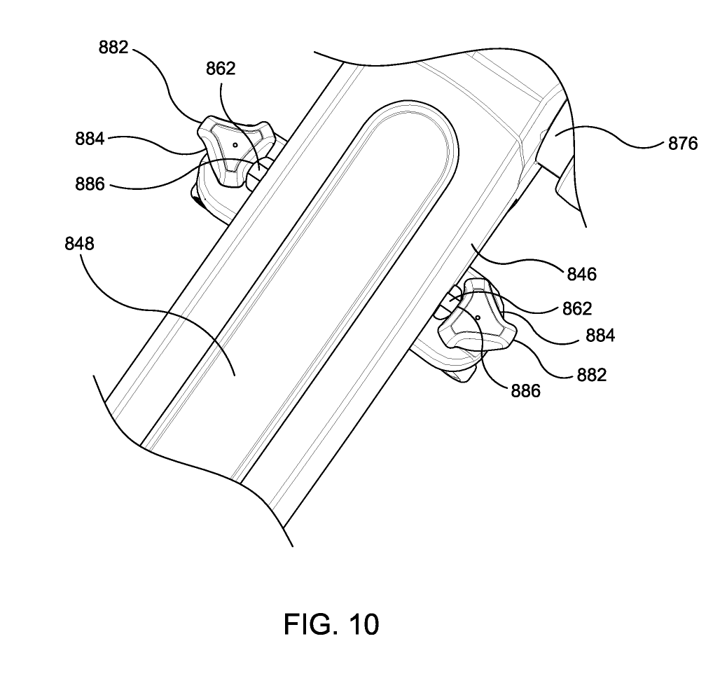

Since base pad 840 may be locked in the closed position via locking mechanism 832, lock(s) 860 may prevent unauthorized removal of clamp(s) 880 from a rack, or portion or a rack (e.g., crossbar 104) by obstructing movement/rotation of actuators 882. This may prevent theft of the load carrier assembly 800. While FIGS. 8-12 show a lock 860 having locking protrusions 862 extending from opposite sides of sidewall 846 so as to obstruct movement/rotation of a set of actuators 882 on a clamp 880, base pad 840 may also include additional locks 860 configured to obstruct movement/rotation of a plurality of or all actuators 882 in load carrier assembly 800. For example, base pad 840 may include two locks 860 having locking protrusions 862 extending from opposite sides of sidewall 846 so as to obstruct movement/rotation of a second set of actuators 882 on a second clamp 880.

In some embodiments, load carrier 810 may include a release tab 834. In some embodiments, locking mechanism 832 may prevent actuation of release tab 834 when locking mechanism 832 is locked. When locking mechanism is unlocked, release tab 834 may be actuated so as to release base pad 840 from support bar 820 (e.g., allow pivotal rotation of base pad 840 from the close position to the open position). In some embodiments, release tab 834 may be located on support bar 820. In some embodiments, release tab 834 may be located on base pad 840. In some embodiments, release tab 834 may be located on or adjacent to the same end of load carrier 810 as locking mechanism 832 (e.g., on or adjacent to first end 812 as shown in FIGS. 8-12). In some embodiments, release tab 834 may be located on or adjacent to the opposite end of load carrier 810 from locking mechanism 832.

In some embodiments, release tab 834 may be configured to actuate a locking member 836 of support bar 820 and/or a locking member 856 of base pad 840. Locking member 836 and locking member 856 may be configured to releasably attach to each other. Locking member 836 may be a male locking member and locking member 856 may be a female locking member, or vice versa. Male locking members include, but are not limited to, bolts, latches, or hooks. Female locking members include, but are not limited to apertures, slots, or openings. In some embodiments, locking members 836, 856 may be located on or adjacent to the same end of load carrier 810 (e.g., first end 812 of load carrier 810/first end 842 of base pad 840). In operation, release tab 834 may be configured to actuate locking member 836 so as to release the locking member 836 from locking member 856, or vice versa. Release tab 834 may include a button, a lever, a switch, etc.

As shown in FIG. 11, when base pad 840 is in the open position, cavity 826 may be exposed and/or accessible by an operator. The opening of cavity 826 may allow an operator to access one or more fasteners 830 disposed within cavity 826 and configured to couple load carrier 810 to one or more clamps 880. Fasteners 830 may couple load carrier 810 to one or more clamps 880 as discussed below in regards to FIG. 13. Since fastener(s) 830 may only be accessible when base pad 840 is in the open and unlocked position, unauthorized access to fastener(s) 830 and therefore unauthorized decoupling of load carrier 810 from clamp(s) 880 can be prevented when base pad 840 is in the closed position.

Also, when base pad 840 is in the open position, actuator(s) 880 of clamp(s) may be actuated (e.g., rotated) so as to untighten clamp(s) 880 from a rack or a portion of a rack (e.g., crossbar 104). Since actuators 882 may only be actuated when base pad 840 is in the open and unlocked position, unauthorized decoupling of clamp(s) 880 from a rack or portion of a rack can be prevented. In this manner, when base pad 840 is in the closed and locked position, base pad 840 may simultaneously prevent unauthorized decoupling or load carrier 810 from clamp(s) 880 and unauthorized removal (i.e., untightening) of clamp(s) 880 from a rack or portion of a rack (e.g., crossbar 104).

In some embodiments, load carrier 810 may include a load support bar 870 coupled to load carrier 810. Load support bar 870 may include a U-shape handle having two arms 872. In some embodiments, load support bar 870 may be pivotally coupled to load carrier 810 and configured to rotate between a first (open) position and a second (closed) position. In some embodiments, load support bar 870 may be pivotally coupled to support bar 820. In some embodiments, arms 872 may be pivotally coupled to support bar 820 via couplings 874. In some embodiments, couplings 874 may include a slide bar 876 configured to slidably receive an arm 872 so as to lock and unlock load support bar 870 in the second (closed) position. In such embodiments, one or both arms 872 may be configured to have limited slidabilty on slide bar 876 in direction 900 shown in FIG. 9. In some embodiments load support bar 870 may be pivotally coupled to support bar 820 at or adjacent to second end 814 of load carrier 810.

In the first position, shown for example in FIG. 8, load support bar 870 may be oriented at a substantially right angle, or slightly more than a right angle, with respect to support bar 820. In the first position, arms 872 may provide a barrier against lateral movement of a load (e.g., sports equipment) in contact with a top surface 848 of base pad 840. Moreover, in the first position, straps or bungee cords may be coupled to load support bar 870 so as to hold a load in contact with top surface 848. In the second (closed) position, load support bar 870 may be oriented substantially horizontal to base pad 840. In some embodiments, all or a portion of top surface 848 of base pad 840 may be padded. In some embodiments, all or a portion of arms 872 may be padded.

FIG. 13 shows a cross-sectional view of an assembled clamp 1300 and load bar carrier 810 according to an embodiment. FIG. 13 also shows a clamp 1300 according to an embodiment. Clamp 1300 may include an upper jaw 1302 and a lower jaw 1310. Clamp 1300 may be configured to attach to a rack or a portion of a rack (e.g., crossbar 104). Upper jaw 1302 and lower jaw 1310 may define, in part, a gap 1326 configured to attach to an exterior surface of a rack or a portion of a rack (e.g., crossbar 104). Gap 1326 may be defined, in part, by lower surface 1309 of upper jaw 1302 and an upper surface 1321 of lower jaw 1310. In some embodiments, the attachment between clamp 1300 and the rack or a portion of a rack may be frictional.

Upper jaw 1302 may include a first end 1304, a second end 1306, an upper surface 1307, and a lower surface 1309. Upper jaw 1302 may include a bolt receiver space 1334 defined within a portion of upper jaw 1302. In some embodiments, bolt receiver space 1334 may be centrally located along the length of upper jaw 1302 (i.e., centrally located between first end 1304 and second end 1306). In some embodiments, bolt receiver space 1334 may be configured to receive a portion of a head of a bolt (e.g., head 1358 of a T-bolt 1350). In some embodiments, bolt receiver space 1334 may be configured to receive the entire head of T-bolt 1350. In some embodiments, bolt receiver space 1334 may be sized and shaped (i.e., dimensioned) to conformance fit with a bolt (e.g., T-bolt 1350). In some embodiments, bolt receiver space 1334 may be configured to receive one or more of a square head bolt, a hex bolt, a hex head flange bolt, and a rail bolt. In such embodiments, bolt receiver space 1334 may be configured to receive the entire head of and/or may be sized and shaped (i.e., dimensioned) to conformance fit with any of these types of bolt heads. In some embodiments, bolt receiver space 1334 may include a through hole extending through upper jaw 1302 from upper surface 1307 of upper jaw 1302 to lower surface 1309 of upper jaw 1302.

Clamp 1300 may include take-up mechanisms 1330, 1331 (e.g., rotary tighteners) configured to adjustably couple lower jaw 1310 to upper jaw 1302. When assembled, take-up mechanisms 1330, 1331 may be received within openings 1303 in upper jaw 1302. In some embodiments, the pivotal coupling between take-up mechanisms 1330, 1331 and lower jaw 1310 at pivot connections 1340, 1341 facilitates the alignment and coupling of upper jaw 1302 and lower jaw 1310. As shown in FIG. 13, take-up mechanisms 1330, 1331 may include a female portion 1374 with a hollow shaft 1375 pivotally coupled to lower jaw 1310 at pivot connections 1340, 1341. In some embodiments, hollow shaft 1375 may include a threaded portion 1376 for releasably receiving a threaded portion 1373 on a male portion 1370 of take-up mechanisms 1330, 1331.

In some embodiments, male portions 1370 may include a tightening bolt 1372 having a threaded portion 1373 for being releasably received by threaded portion 1376 of female portions 1374. In some embodiments, tightening bolt 1372 may include a first end coupled to an actuator 1362 and a second end including threaded portion 1373. Actuator 1362 may be configured to tighten and untighten clamp 1300 when rotated. In some embodiments, actuator(s) 1362 may be the same as or similar to actuator 882. In some embodiments, actuator(s) 1362 may be the same as or similar to pinch-engagement actuator 114.

FIG. 13 also shows a releasable connection between clamp 1300 and load carrier 810 via a bolt (e.g., a T-bolt 1350). As shown in FIG. 13, T-bolt 1350 may be received within bolt receiver space 1334 of upper jaw 1302 such that a portion of a shaft 1359 of T-bolt 1350 extends above upper surface 1307 of upper jaw 1302. As shown in FIG. 13, support bar 820 may include at least one through hole 821 extending through bottom wall 822 that is configured to receive shaft 1359. Through hole(s) 821 may extend through bottom wall 822 such that they are in communication with cavity 826. When assembled, a portion of shaft 1359 may extend above an attachment surface 828 of bottom wall 822 such that fastener 830 can be releasably coupled to shaft 1359 within cavity 826.

In some embodiments, shaft 1359 may include threading for releasably coupling to fastener 830. In some embodiments, fastener 830 may include a nut (e.g., hex nut or wing nut) with threading configured to releasably engage the threading on shaft 1359 of T-bolt 1350. In such embodiments, fastener 830 may be tightened and untightened by rotating fastener 830. In some embodiments, fastener 830 may include a gripping portion configured to facilitate rotation (and thus tightening/untightening) of fastener 830 by an operator's hand.

While fastener 830, and the connection between fastener 830 and T-bolt 1350, has been described as being threaded, other types of fasteners may be used, including but not limited to, luer-lock fasteners, snap-fit fasteners, and pin/slot fasteners. In operation, the engagement between fastener 830 and T-bolt 1350 releasably secures clamp 1300 to load carrier 810 (e.g., by holding upper surface 1307 of upper jaw 1302 against a lower surface 823 of support bar 820 of load carrier 810).

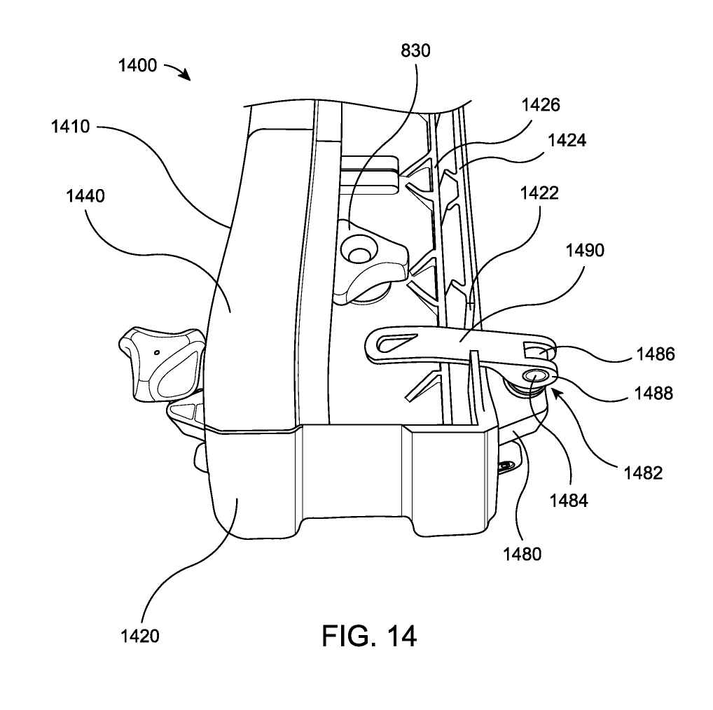

FIG. 14 shows a load carrier assembly 1400 according to an embodiment. Load carrier assembly may include a load carrier 1410 and one or more clamps 1480. Load carrier 1410 may include a support bar 1420 and a base pad 1440, which may be the same as or similar to support bar 820 and base pad 840, respectively. FIG. 14 shows a partial cut-away of base pad 840 showing cavity 1426 defined by support bar 1420 and base pad 1440. Cavity 1426 may be the same as or similar to cavity 826. For example, as shown in FIG. 14, cavity may be configured to house a fastener 830 for releasably coupling a clamp 1480 to load carrier 1410.

Clamp(s) 1480 may be the same as or similar to clamps 880 discussed herein. In one embodiment, clamp(s) 1480 include one or more flip-fasteners 1482. Flip-fastener 1482 may include a cam 1488 having at least one aperture 1484 extending horizontally through a width of cam 1488 and configured to receive a barrel nut 1486. Barrel nut 1486 may be releasably or permanently coupled to a tightening bolt of a take-up mechanism of clamp 1480 (e.g., tightening bolt 1372 of take-up mechanism 1330). Cam 1488 may be rotatably coupled to barrel nut 1486 at aperture 1484 such that a lever arm 1490 of flip-fastener 1482 is able to pivot between a horizontal (closed) position (shown in FIG. 14) and a vertical (open) position.

In operation, load carrier 1410 may be configured to obstruct movement/rotation of flip-fastener 1482 (and therefore tightening and untightening of a clamp 1480). In some embodiments, load carrier 1410 may include an aperture 1422 configured to receive at least a portion of lever arm 1490 when flip-fastener 1482 is in the closed position. In some embodiments, aperture 1422 may be formed, in whole or in part, in support bar 1420. In some embodiments, aperture 1422 may be formed, in whole or in part, in base pad 1440. In some embodiments, as shown in FIG. 14, aperture 1422 may be slot extending through a sidewall 1424 of support bar 1420 and in communication with cavity 1426 defined by support bar 1420 and base pad 1440. In some embodiments, aperture 1422 may be a slot extending through a sidewall of base pad 1440 and in communication with cavity 1426.

In operation, flip-fastener 1482 may be rotated so as to attach (i.e., tighten) clamp 1480 to a rack or a portion of a rack (e.g., crossbar 104) while flip-fastener 1482 is in the vertical position. Before or after tightening of clamp 1480, base pad 1440 may be rotated to the open position (e.g., as shown in FIG. 11 for base pad 840). Once clamp 1480 is tightened and base pad 1440 is in the open position, flip-fastener 1482 may be pivoted to the horizontal position such that at least a portion of lever arm 1490 extends into and/or through aperture 1422.

In embodiments where aperture 1422 is a slot extending through sidewall 1424 of support bar 1420, lever arm 1490 may extend through the slot into the portion of cavity 1426 defined by support bar 1420. In embodiments where aperture 1422 is formed in base pad 1440, lever arm 1490 may be pivoted to the horizontal position such that it is positioned above support bar 1420 and in a position to be received by aperture 1422 formed in base pad 1440 when base pad 1440 is in the closed position. In either case, when base pad 1440 is rotated to the closed position (e.g., as shown in FIG. 9 for base pad 840), lever arm 1490 may be locked in the horizontal position with a portion of lever arm 1490 located within cavity 1426. In this manner, lever arm 1490 may include an interference surface (e.g., the surfaces of sidewalls of lever arm 1490) that engages or is disposed immediately adjacent to aperture 1422 to thereby obstruct movement/rotation of flip-fastener 1482. Since base pad 1440 may be locked in the closed position (e.g., via locking mechanism 832 as discussed above), unauthorized removal of load carrier 1410 from clamp(s) 1480 may be prevented.

While FIG. 14 shows a clamp 1480 having only a single flip-fastener 1482, a clamp 1480 may have two flip-fasteners 1482, each flip-fastener 1482 having the same functionality as discussed herein. In such embodiments, load carrier 1410 may have a plurality of apertures 1422.

The load carrier assemblies discussed herein, and portions thereof, can be employed to carry and/or support a load, such as a bicycle, skis, a cargo container, a kayak, a canoe, and other objects.

The various embodiments described above are provided by way of illustration only and should not be construed to limit the scope of the disclosure. Various modifications and changes can be made to the principles and embodiments described herein without departing from the scope of the disclosure and without departing from the claims which follow.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention(s) that others can, by applying knowledge within the skill of the art, readily modify and/or adapt for various applications such specific embodiments, without undue experimentation, without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention(s) should not be limited by any of the above-described exemplary embodiments, but should be defined only in accordance with the following claims and their equivalents.

What is claimed is:

1. A load carrier assembly, comprising:
a clamp configured to attach to a crossbar; and
a load carrier coupled to the clamp, the load carrier comprising:
a support bar, and
a base pad pivotally coupled to the support bar,
wherein the base pad is configured to rotate between a closed position and an open position, and
wherein the base pad is configured to obstruct tightening and untightening of the clamp in the closed position.

2. The load carrier assembly of claim 1, wherein the clamp comprises a tightening bolt coupled to an actuator configured to tighten and untighten the clamp.

3. The load carrier assembly of claim 2, wherein the base pad is configured to obstruct rotation of the actuator in the closed position.

4. The load carrier assembly of claim 2, wherein the base pad comprises a lock configured to engage the actuator in the closed position to obstruct rotation of the actuator.

5. The load carrier assembly of claim 4, wherein the lock comprises a protrusion extending outwardly from a sidewall of the base pad.

6. The load carrier assembly of claim 1, comprising a locking mechanism configured to lock and unlock the base pad in the closed position.

7. The load carrier assembly of claim 1, further comprising a load support bar coupled to the load carrier.

8. The load carrier assembly of claim 7, wherein the load support bar is pivotally coupled to the load carrier and configured to rotate between a first position and a second position.

9. The load carrier assembly of claim 7, wherein the load support bar comprises a U-shape having two arms pivotally coupled to the load carrier.

10. The load carrier assembly of claim 1, wherein the load carrier comprises a cavity defined by the support bar and the base pad, and wherein the cavity is closed when the base pad is in the closed position.

11. The load carrier assembly of claim 10, further comprising a fastener coupling the load carrier to the clamp and disposed within the cavity.

12. The load carrier assembly of claim 11, wherein the fastener is configured to releasably couple to a bolt coupled to the clamp.

13. The load carrier assembly of claim 1, comprising two clamps, each clamp configured to attach to a crossbar, wherein the load carrier extends between the two clamps and is coupled to the two clamps.

14. The load carrier assembly of claim 1, wherein the clamp comprises a rotary tightener having an actuator, the rotary tightener configured to adjustably couple a lower jaw of the clamp to an upper jaw of the clamp.

15. A load carrier, comprising:
a support bar comprising a through hole extending through a bottom wall of the support bar and configured to receive a bolt;
a base pad pivotally coupled to the support bar and configured to rotate between a closed position and an open position;
a locking mechanism disposed on the load carrier and configured to lock and unlock the base pad in the closed position; and
a cavity defined by the support bar and the base pad,
wherein the cavity is closed when the base pad is in the closed position, and wherein the through hole is in communication with the cavity.

16. The load carrier of claim 15, wherein the cavity is open when the base pad is in the open position.

17. The load carrier of claim 15, further comprising a load support bar pivotally coupled to the support bar and configured to rotate between a first position and a second position.

18. A load carrier having a load engagement portion and a plurality of lockable brackets comprising:
a pair of lockable brackets with a load engagement portion positioned therebetween, each of the pair of brackets comprising:
a tightenable clamp having an interior configured to matingly engage about an exterior of a crossbar;
a rotary tightener coupled between two portions of the tightenable clamp; and
a pinch-engagement actuator coupled to the rotary tightener for transitioning the rotary tightener between a securing and a releasing configuration;
wherein the pinch-engagement actuator comprises an interference surface on a lateral side thereof that abuttingly engages the load engagement portion, thereby preventing rotation of the rotary tightener and preventing unauthorized removal of the load carrier from the crossbar.

19. A load carrier assembly for releasably securing a load to a crossbar of a vehicular roof rack, the load carrier assembly comprising:
a clamp comprising an upper jaw and a lower jaw configured to frictionally attach to an exterior of a crossbar;
a load carrier coupled to the clamp;
a rotary tightener coupled the upper jaw and the lower jaw of the clamp;
an actuator coupled to the rotary tightener, the actuator comprising an interference surface that abuttingly engages a portion of the load carrier in a locked configuration to thereby obstruct rotation of the rotary tightener.

20. The load carrier assembly of claim 19, wherein the actuator is able to rotate when the load carrier assembly is in an un-locked configuration.
